(19) United States
(12) Patent Application Publication
(10) Pub. No.: US 2010/0106746 A1
(43) Pub. Date: Apr. 29, 2010

(54) MODULAR INTERFACE FOR DATABASE CONVERSION

(75) Inventor: Werner Mok, Rockville, MD (US)

Correspondence Address: COMPUTER PATENT ANNUITIES NORTH AMERICA, LLC;C/O CPA GLOBAL, P.O. BOX 52050, MINNEAPOLIS, MN, 55402, US

(73) Assignee: FOUNDATIONIP, LLC, Minneapolis, MN (US)

(21) Appl. No.: 12/607,947

(22) Filed: Oct. 28, 2009

Related U.S. Application Data
(60) Provisional application No. 61/108,952, filed on Oct. 28, 2008.

(51) Int. Cl. G06F 17/30

(52) U.S. Cl. 707/802; 707/E17.045

(57) ABSTRACT

A system, method and article of formatted information and data exchange for universal, modular, data conversion from one relational database to another, while bypassing any formatting on the source database.

### BACKGROUND OF THE INVENTION

In database conversion scenarios where the formats of the source data does not match the format of the target database, significant resources are typically expended in attempting to perform the conversion without creating errors or losing critical source data. Often times, third-party software becomes involved to clean or transform the source data prior to uploading into a target database. In data-critical applications, such as banking, medical, and intellectual property applications, losing or corrupting a single record during data conversion could have dire consequences.

Clients with databases that wish to convert to new data management applications have not had an option of a standard technique to convert data from any format and type without using any additional software or manual data manipulation.

### SUMMARY OF THE INVENTION

The preferred and alternative embodiments of the present invention provide a system and method for data conversion that utilizes resources already contained in the source database software, thus eliminating the need for third-party software intervention, to execute configured scripts. The present invention is universal in its application, thereby being able to convert from any relational database to any other automatically.

### BRIEF DESCRIPTION OF THE DRAWINGS

For a better understanding of the nature of the present invention, its features and advantages, the subsequent detailed description is presented in connection with accompanying drawings in which:

FIG. 1 is a network system that is capable of implementing the exemplary embodiments for data conversion;

FIG. 2 is a functional network system diagram of the preferred and alternative embodiments;

FIG. 3 is a flowchart of an embodiment of data conversion; and

FIG. 4 is a block of computer components illustrating placement of the preferred protocol process module and applications as tools in a computer system;

### DETAILED DESCRIPTION OF THE INVENTION

There is described herein preferred and exemplary embodiments for a system and method for data and information and data transfer between databases. In one embodiment, intellectual property data and information is converted into a strict format using a client's original DTS database package and without using further third-party conversion software or manual conversion steps.

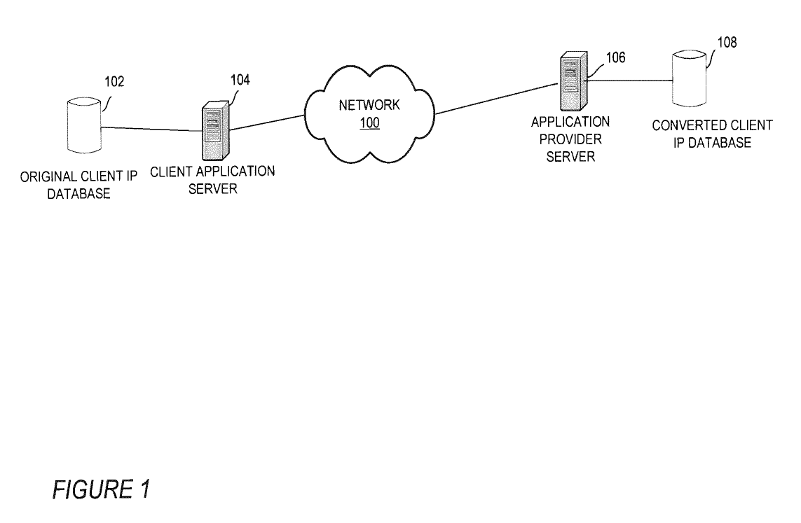

Referring to FIG. 1, a computer network system capable of implementing the preferred and alternative embodiments is illustrated. Users and servers connect to a broadband network 100, such as the public Internet, managed network lines, and/or a private wide area networks (WAN). Each server and end-user can connect to the Internet 100 through a standard or high-speed network connection such as Ethernet LAN, cable modem, DSL (“Digital Subscriber Line”) or T1/T5 line.

A first specialized client database application server 104 handles and executes a first intellectual property (IP) management database application that accesses original client IP database 102. A second specialized application server 106 handles and executes a second intellectual property (IP) management database application that accesses converted client IP database 108.

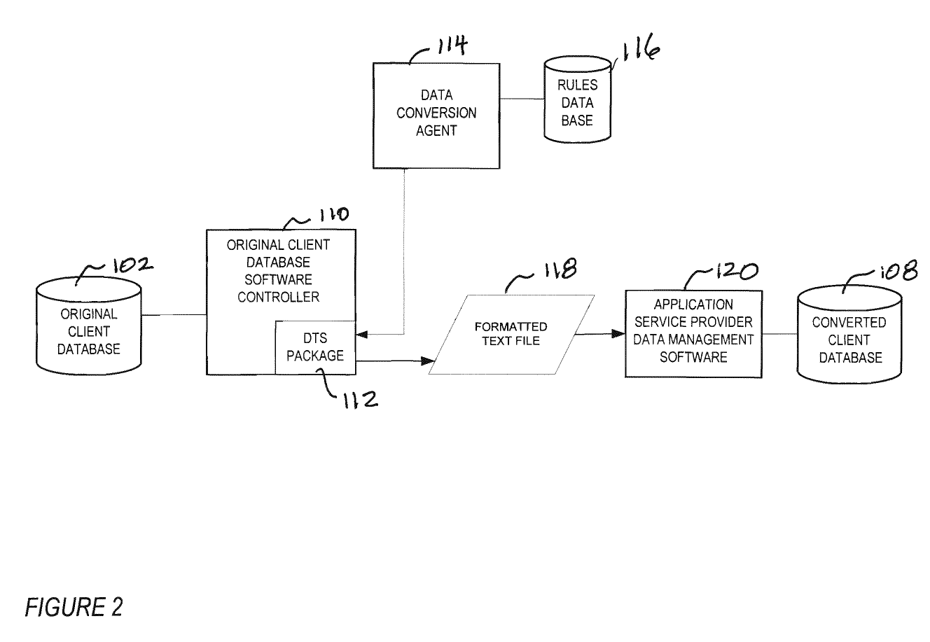

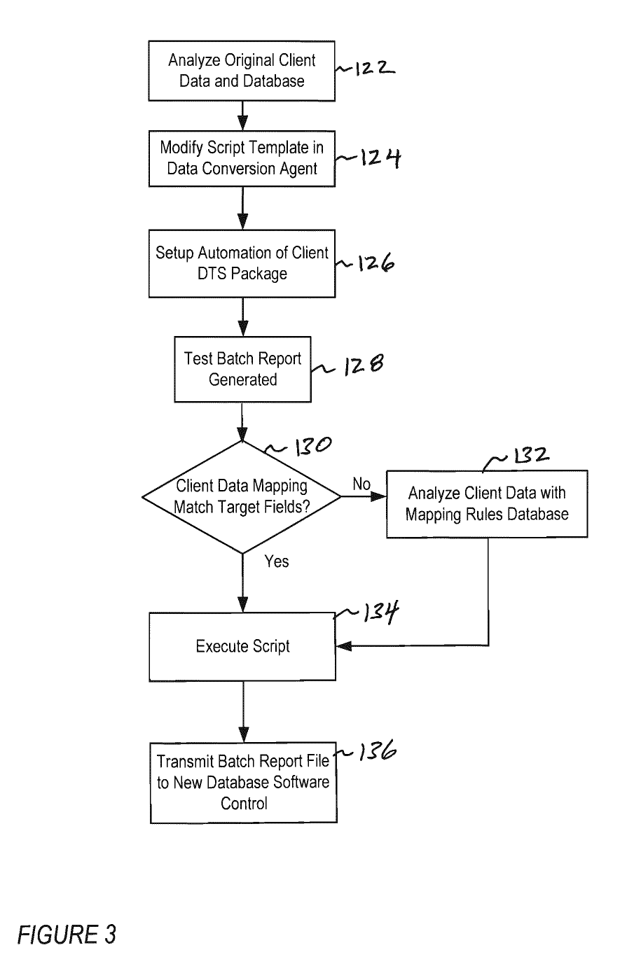

Reference is made to FIG. 2, which contains a functional flowchart illustrating a method and system of the embodiments. Reference is also made to FIG. 3, illustrating a method of the embodiments. In step 122, original client data from IP database 102 is accessed through software 110 and analyzed to determine location of and identify tables, records, fields, and indexes. Database 102 is a relational database, Access to database 102 can be via network 100, directly through controller software 110, or a copy of database 102 on a computer-readable media.

A script template is created with data conversion agent 114 as an SQL script template comprising SQL SELECT statements that format and extract client data from database 102. This template is modified 124 based on an analysis to fit client database 102 environment and retrieving critical data fields used in ASP database 108. This is performed in part by configuring the FROM portion of the SELECT statement, thereby configuring the table relationships or joins to pull all necessary fields from client data 102 that are necessary for database 108. Data fields from original client data 102 must be mapped to custom data fields and tables in converted client database 108 that can be used by management software 120 on IP Application Provider Server 106. For intellectual property purposes, databases used by IP application management software 120 contain specialized fields that are used in the patent and trademark industry, such as:
Country Code
Renewal Type code
Entity Size
Priority Date
Application Filing Date
Publication Date
Grant Date
Renewal Date

IP databases can include up to a hundred or more specific data fields as are known in the art. It is records in those fields and tables that must be converted between old client database 102 and new database 108. In modifying script 124, all code lookups and conversion logic can be built into the SELECT statement.

In step 126, automation of the configured script is setup to execute on the claim database software DTS controller 112. Data conversion agent 114 executes directly within DTS 112, which then connects directly with original client database 102. No other third-party software or conversion mechanism is needed to execute the SQL script against client database 102. The modified script can bypass any client data source 102 format since the scripts will be executed directly against the client database (e.g., SQL server, Oracle, etc.). Automation parameters 126 are setup in order save retrieved data from database 102 into ASP 106 batch report layout or format. SQL templates can be modified via any text editor and executed using any type of DTS package 112 without requiring additional software input from either client controller 110 or ASP data management software 120.

After execution, a test batch, or report of extracted client data 102 is generated 128 using the configured SQL script of agent 114. In step 130, if the test batch, 128, if the data mapping from the client data 102 does not match the target fields in database 108, then client data 102 fields are analyzed 132 against a rules database 116 via data conversion agent 114. Rules database 116 contains text and data conversion rules to convert records such as “Patent” from client data 102 into a single character “P” that is used by ASP management software 120. Another example is if a date from data 102 is in a format other than the format specified by application software 120, then rules 116 can be applied to recognize and convert the alpha-numeric date records into proper format.

After setup 126 and analyzing the data mapping 130, DTS package 112 executes the SQL script 134 and produces a formatted batch report 118, which is a text file in the embodiment. The configured script can be scheduled to run automatically 136 in DTS package 112 and to combine, encrypt, and e-mail out one or more batch files 118 to Application management software 112.

SQL is a universal computer language, therefore users of client software 110 can customize and perform setup and automation activities without needed much, if any, third-party assistance. This allows users of client database software 110 to take advantage of standard database tools in order to understand, configure, and execute the script. There are no version or maintenance issues with the embodiments and no interface to maintain in the method and system of the embodiments, since the scripts execute directly within DTS package 112, which is a typical module included within client database software 110. Further, the use of configured SQL scripts reduces the risk of data corruption in database conversions.

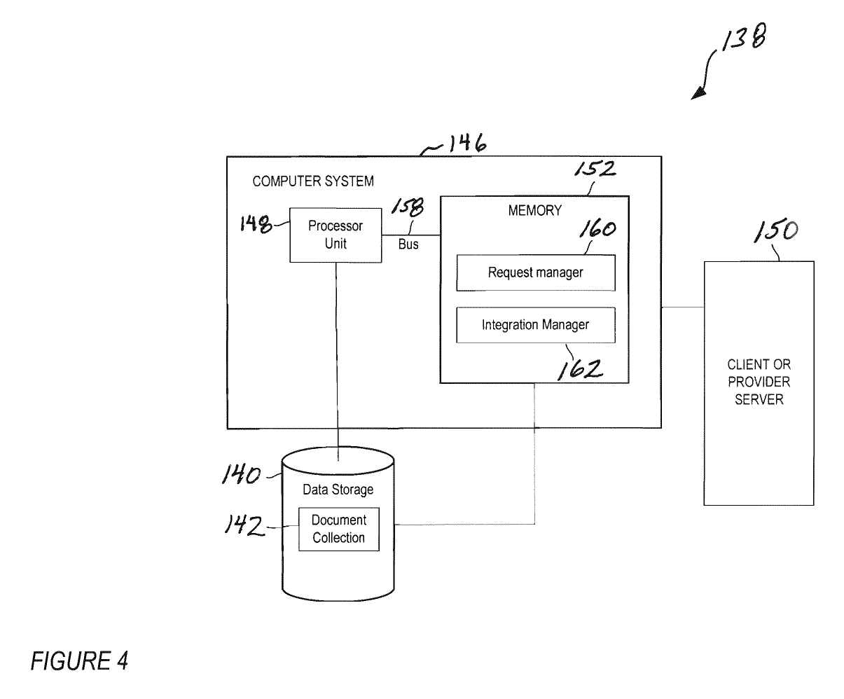

FIG. 4 is a block diagram 138 illustrating placement of an exemplary database manager application, such as application 110 or 120 and database 140, such as databases 102 or 108, as hardware tools in a computer system. The diagram shows a computer system 146 with a processor unit (148) coupled to memory 152 by a bus structure 158. Although only one processor unit 148 is shown, in one embodiment, the computer system 146 may include more processor units in an expanded or distributed design. The computer system includes data storage 140 in communication with the processor unit 148. The data storage unit is employed for retention of a collection of relational data 142.

A request manager 160 is provided in communication with the system 146. However, in one embodiment, the request manager may be on a remote system (not shown) that is in communication with the system 502 across a network. The request manager 160 monitors information associates with data 142 retained on the data storage 140. Upon detection of an event or execution, the request manager 160 generates a message and communicates the message to an integration manager 162. As with the request manager, the integration manager may be local to the system 146 or on a remote system (not shown) that is in communication with the system 146 across a network. The integration manager 162 is also in communication with the data 142 retained on the data storage 140.

As shown herein, the request manager 160 and the integration manager 162 each reside in memory 160 local to the computer system 514602. In one embodiment, each of the managers 160 and 162 may reside as hardware tools external to local memory 152, or may be implemented as a combination of hardware and software. Similarly, in one embodiment, the managers 160 and 162 may be combined into a single functional item that incorporates the functionality of the separate items. In one embodiment managers 160 and 162 may be collectively or individually distributed across a network and function as a unit. Accordingly, the managers 160 and 162 may be implemented as software tools, hardware tools, or a combination of software and hardware tools.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

It will be appreciated that, although specific embodiments of the invention have been described herein for purposes of illustration, various modifications may be made without departing from the spirit and scope of the invention. In particular, a unique name may be assigned to one of the blocks of data employed in the executed query. Accordingly, the scope of protection of this invention is limited only by the following claims and their equivalents.

What is claimed:

1. A computer implemented method for providing database conversion, comprising:
providing client data in a relational database on a client server;
configuring a script to extract and map the client data to a target database format;
executing the script within a DTS package, on the client server, of the client relational database; and
creating a report, as a result of the script execution, of the client data that is formatted according to the target database format.
